(19) United States
(12) Patent Application Publication
(10) Pub. No.: US 2006/0238530 A1
(43) Pub. Date: Oct. 26, 2006

(54) Micro-mirror element and method

(75) Inventor: Cuiling Gong, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/110,028

(22) Filed: Apr. 20, 2005

(51) Int. Cl. G09G 5/00

(52) U.S. Cl. 345/207

(57) ABSTRACT

According to one embodiment of the present invention a micro-mirror element comprises a lower layer, a middle layer, and a micro-mirror. The middle layer includes at least one hinge. The entire middle layer is operable to receive a bias charge. The micro-mirror is operable to receive the bias charge from the middle layer.

### TECHNICAL FIELD OF THE INVENTION

This invention relates in general to image display systems, and more particularly to a micro-mirror element and method.

### BACKGROUND OF THE INVENTION

Light processing systems often involve directing light towards a display such that an image is produced. One way of effecting such an image is through the use of digital micro-mirror devices (DMD) available from Texas Instruments. In general, light is shined on a DMD array having numerous micro-mirrors. Each micro-mirror is selectively controlled to reflect the light towards a particular portion of a display, such as a pixel. The angle of a micro-mirror can be changed to switch a pixel to an “on” or “off” state. The micro-mirrors can maintain their “on” or “off” state for controlled display times.

### SUMMARY OF THE INVENTION

According to one embodiment of the present invention a micro-mirror element comprises a lower layer, a middle layer, and a micro-mirror. The middle layer includes at least one hinge. The entire middle layer is operable to receive a bias charge. The micro-mirror is operable to receive the bias charge from the middle layer.

Certain embodiments may provide a number of technical advantages. For example, a technical advantage of one embodiment may include the capability to provide a decreased digital micro-mirror device (DMD) mirror size. Another technical advantage of another embodiments may include the capability to provide an increased DMD resolution. Other technical advantages of other embodiments may include the capability to provide a scalable DMD pixel element.

Although specific advantages have been enumerated above, various embodiments may include all, some, or none of the enumerated advantages. Additionally, other technical advantages may become readily apparent to one of ordinary skill in the art after review of the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a block diagram of one embodiment of a portion of a display system;

FIG. 2 illustrates an example configuration of a conventional digital micro-mirror device (DMD) pixel element;

FIG. 3A illustrates another configuration of a conventional digital micro-mirror device (DMD) pixel element;

FIGS. 3B and 3C generally illustrate top isolated views of components of the conventional DMD pixel element of FIG. 3A as divided into a lower layer and a middle layer, respectively;

FIG. 3D generally shows an side isolated view of the micro-mirror of FIG. 3A tilting towards an address pad and an address electrode;

FIGS. 4A and 4B illustrate a DMD pixel element, according to an embodiment of the invention;

FIGS. 4C and 4D illustrate top isolated views of components of the embodiment of the DMD pixel element of FIGS. 4A and 4B as divided into a lower layer and a middle layer, respectively; and

FIG. 4E shows a side isolated view of the micro-mirror of FIGS. 4A and 4B tilting towards an address pad, according to an embodiment of the invention.

### DETAILED DESCRIPTION OF EXAMPLE EMBODIMENTS

It should be understood at the outset that although example implementations of embodiments of the invention are illustrated below, the present invention may be implemented using any number of techniques, whether currently known or in existence. The present invention should in no way be limited to the example implementations, drawings, and techniques illustrated below. Additionally, the drawings are not necessarily drawn to scale.

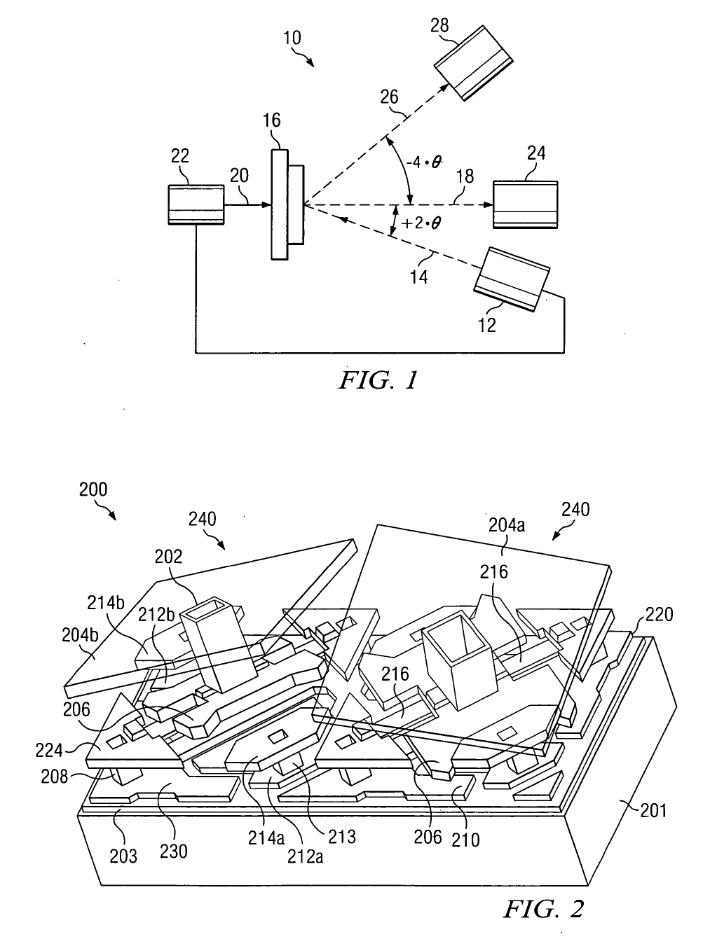

FIG. 1 is a block diagram of one embodiment of a portion of a display system 10. In this example, display system 10 includes a light source module 12 capable of generating illumination light beams 14. Light beams 14 are directed from light source module 12 to a modulator 16. Modulator 16 may comprise any device capable of selectively communicating at least some of the received light beams along a projection light path 18. In various embodiments, modulator 16 may comprise a spatial light modulator, such as, for example, a liquid crystal display, a light emitting diode modulator, or a liquid crystal on silicon display. In the illustrated embodiment, however, modulator 16 comprises a digital micro-mirror device (DMD).

As will be described in more detail below, a DMD is a micro electromechanical device comprising an array of hundreds of thousands of tilting digital micro-mirrors. In a flat state, each micro-mirror may be substantially parallel to projection lens 24. From the flat state, the micro-mirrors may be tilted, for example, to a positive or negative angle corresponding to an “on” state and an “off” state. For discussion purposes, the angle at which the mirrors may tilt will be measured from projection path 18 and may be designated as theta. In particular embodiments, the micro-mirrors may tilt from +10 degrees to a −10 degrees. In other embodiments, micro-mirrors may tilt from a +12 degrees to a −12 degrees. To permit the micro-mirrors to tilt, each micro-mirror attaches to one or more hinges mounted on support posts, and spaced by means of an air gap over underlying control circuitry. The control circuitry provides the desired voltages to the respective layers, based at least in part on image data 20 received from a control module 22. In various embodiments, modulator 16 is capable of generating various levels or shades for each color received.

The electrostatic forces cause each micro-mirror to selectively tilt. Incident illumination light on the micro-mirror array is reflected by the “on” micro-mirrors along projection path 18 for receipt by projection lens 24. Additionally, illumination light beams 14 are reflected by the “off” micro-mirrors and directed on off-state light path 26 toward light dump 28. The pattern of “on” versus “off” mirrors (e.g., light and dark mirrors) forms an image that is projected by projection lens 24. As used in this document, the terms “micro-mirrors” and “pixels” are used inter-changeably.

Light source module 12 includes one or more lamps or other light sources capable of generating and focusing an illumination light beam. Although display system 10 is described and illustrated as including a single light source module 12, it is generally recognized that display system 10 may include any suitable number of light sources modules appropriate for generating light beams for transmission to modulator 16.

In particular embodiments, light source module 12 is positioned such that light beam 14 is directed at modulator 16 at an illumination angle of twice theta (where theta is equal to the degree of tilt of the micro-mirror). For example, where the micro-mirrors tilt from approximately +10 to +12 degrees (“on”) to approximately −10 to −12 degrees (“off”), light beam 14 may be directed at modulator 16 from light source module 12 positioned at an angle of approximately +20 to +24 degrees from projection path 18. Accordingly, light beam 14 may strike modulator 16 at an angle of approximately +20 to +24 degrees relative to the normal of the micro-mirrors when the micro-mirrors are in a flat state or an untilted position.

Off state light path 26 is at a negative angle that is approximately equal to four times theta. Thus, where the micro-mirrors are positioned at approximately −10 to −12 degrees when in the “off” state, light beam 14 is reflected at an angle of approximately −40 to −48 degrees as measured from projection path 18.

As discussed above, display system 10 includes a control module 22 that receives and relays image data 20 to modulator 16 to effect the tilting of micro-mirrors in modulator 16. Specifically, control module 22 may relay image data 20 that identifies the appropriate tilt of the micro-mirrors of modulator 16. For example, control module 22 may send image data 20 to modulator 16 that indicates that the micro-mirrors of modulator 16 should be positioned in the “on” state. Accordingly, the micro-mirrors may be positioned at a tilt angle on the order of approximately +10 to +12 degrees, as measured from projection path 18. Alternatively, control module 22 may send image data 20 to modulator 16 that indicates that the micro-mirrors should be positioned in the “off” state. As such, the micro-mirrors may be positioned at a tilt angle on the order of approximately −10 to −12 degrees, as measured from projection path 18.

FIG. 2 illustrates an example configuration of a conventional DMD pixel element 200. As discussed above with regard to modulator 16 of FIG. 1, DMD 200 may include an array of hundreds of thousands of tilting digital micro-mirrors. Each micro-mirror may be on an individually addressable DMD pixel element 240. Although DMD 200 includes many of such DMD pixel elements 240, for illustration purposes, only two DMD pixel elements 240 are shown in FIG. 2.

Each DMD pixel element 240 may generally include a superstructure cell fabricated monolithically over a complementary metal-oxide semiconductor (“CMOS”) substrate 201. In particular embodiments, the CMOS substrate 201 includes component parts of control circuitry operable to manipulate the DMD pixel element 240. For example, the CMOS substrate 201 may include an SRAM cell or other similar structure for performing the operations of DMD pixel element 240. Each DMD pixel element 240 may generally include a mirror portion, a hinge portion, and an address portion.

The mirror portion of the DMD pixel elements 240 in the illustrated embodiment uses a reflective material such as aluminum or other material to reflect incident light to produce an image through projection lens 24. In some embodiments, the reflective material may be a micro-mirror 204. In particular embodiments, the micro-mirror 204 may be approximately 13.7 microns in size and have approximately a one micron gap between adjacent micro-mirrors. The described dimensions, however, are merely one example configuration of micro-mirrors 204. It is generally recognized that, in other embodiments, each micro-mirror 204 may be smaller or larger than the above described example. For example, in particular embodiments, each micro-mirror may be less than thirteen microns in size. In other embodiments, each micro-mirror may be approximately seventeen microns in size.

The hinge portion of the DMD pixel elements 240, in the illustrated embodiment, includes one or more hinges 216 mounted with beams 224, which are supported by hinge posts or hinge vias 208. The hinges 216 may be made of aluminum, titanium, tungsten, aluminum alloys, such as AlTiO, or other material suitable for supporting and manipulating micro-mirrors 204. In operation, the one or more hinges 216 may be used to tilt each micro-mirror 204 such that the micro-mirrors 204 may be alternated between an active “on” state or an active “off” state. For example, and as described above with regard to FIG. 1, hinges 216 may operate to tilt micro-mirrors 204 from a plus ten degrees to a minus ten degrees to alternate the micro-mirrors 204 between the active “on” state condition and the active “off” state condition, respectively. In other example embodiments, however, hinges 216 may operate to tilt micro-mirrors 204 from a plus twelve degrees to a minus twelve degrees to alternate the micro-mirrors 204 between the active “on” state and the active “off” state, respectively.

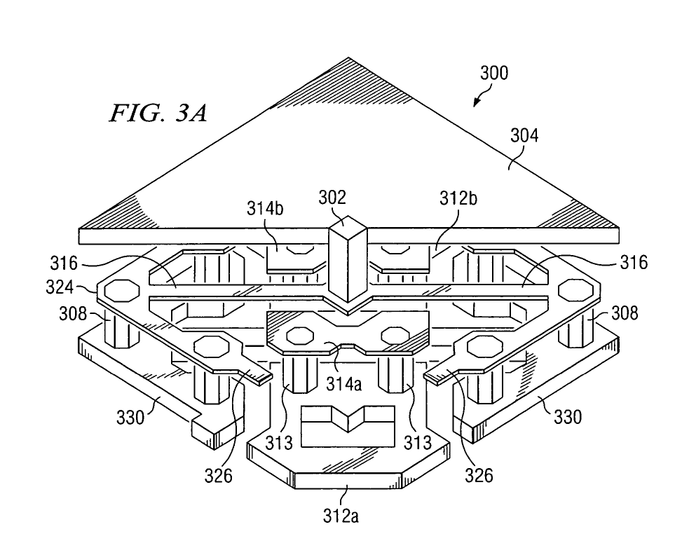

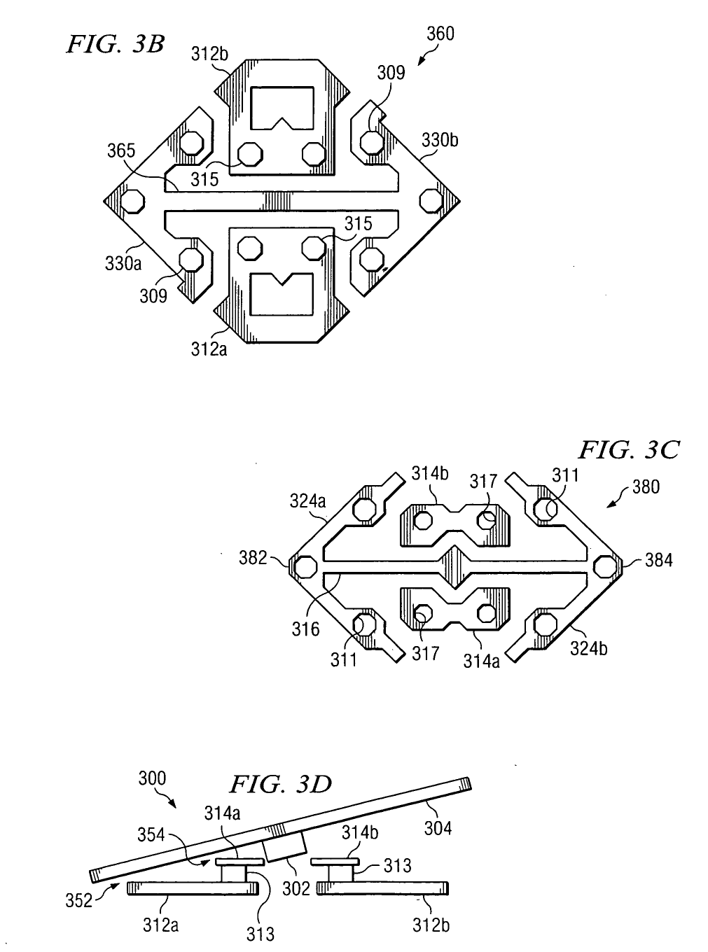

The micro-mirrors 204 are generally supported above the hinge 216 by a mirror via 202. In the illustrated embodiment, the range of motion given to micro-mirrors 204 may be limited by a yoke 206. Thus, micro-mirrors 204 may be tilted in the positive or negative direction until the yoke 206 (coupled to or integrated with the hinge 216) contacts a contact point 210 of a bias pad 230. Although this example includes yoke 206, however, for limiting the motion of micro-mirrors 204 to a desired range, it is generally recognized that other embodiments may eliminate the yoke 206. For example, it is generally recognized that micro-mirrors 204 may tilt in the positive or negative direction until the micro-mirrors 204 contact a mirror stop or spring tip (shown and described in more detail with regard to FIGS. 3B-3C).

The address portion of the DMD pixel elements 240, in the illustrated embodiment, includes a pair of address pads 212a, 212b and address electrodes 214a, 214b. Address vias 213 may generally couple the address electrodes 214a, 214b to a portion of the address pads 212a, 212b. The address electrodes 214a, 214b that carry a control or address voltage are in closer proximity to the micro-mirrors 204 when the mirrors tilt. Further details of the control or address voltage are described below.

In the illustrated embodiment, the address pads 212a, 212b and the bias pad 210 are formed within a conductive layer 220 (also referred to sometimes as a Metal 3 or M3 layer). The conductive layer 220 is disposed outwardly from an oxide layer 203, which operates as an insulator. For example, the oxide layer 203 may at least partially insulate CMOS substrate 201 from address pads 212a, 212b and bias pad 210. As another example, the oxide layer 203 may additionally or alternatively operate to at least partially insulate the address electrodes 212a, 212b from the bias pad 230.

In operation, portions of the DMD pixel elements 240 may receive a bias voltage that at least partially contributes to the creation of the electrostatic forces (e.g., a voltage differential) between the address portions, which includes the address pads 212 and the address electrodes 214, and the micro-mirrors 204. Additionally or alternatively, the bias voltage may contribute to the creation of electrostatic forces between the address portions of the DMD pixel elements 240 and the yoke 206. For example, a bias voltage may be applied to the bias pad 230. The bias voltage may conductively travel from bias pad 230 through hinge vias 208, hinge 216, yoke 206, and mirror via 202 to micro-mirror 204. In particular embodiments, the bias voltage comprises a steady-state voltage. That is, the bias voltage applied to portions of the DMD pixel element 240 remains substantially constant while the DMD 200 is in operation. In particular embodiments, the bias voltage is on the order of approximately twenty-six volts. However, the described bias voltage is merely one example of a bias voltage that may be used to operate DMD 200. It is generally recognized that other bias voltages may be used without departing from the scope of the present disclosure.

As described above, CMOS substrate 201 comprises control circuitry associated with DMD 200. The control circuitry may comprise any hardware, software, firmware, or combination thereof capable of at least partially contributing to the creation of the electrostatic forces between the address portions (e.g., the address pad 212 and the address electrodes 214) and the micro-mirrors 204 and/or the address portions and the yoke 206. The control circuitry associated with CMOS substrate 201 functions to selectively transition micro-mirrors 204 between “on” and “off” states based at least in part on data received from a controller or processor (shown in FIG. 1 as reference numeral 22).

The illustrated example embodiment includes two micro-mirrors 204 disposed adjacent to one another. Micro-mirror 204a may represent a micro-mirror in the active “on” state condition. Conversely, micro-mirror 204b may represent a micro-mirror in the active “off” state condition. Thus, the control circuitry associated with CMOS substrate 201 transitions micro-mirrors 204 between “on” and “off” states by selectively applying an address or control voltage to at least one of the address electrodes 212a, 212b associated with a particular micro-mirror 204. In particular embodiments, the control voltage is on the order of approximately three volts. Accordingly, to transition micro-mirror 204b, for example, to the active “on” state condition, the control circuitry removes the control voltage from electrode 212a (reducing, for example, electrode 212a from three volts to zero volts) and applies the control voltage to electrode 212b (increasing, for example, electrode 212b from zero volts to three volts) while the micro-mirror receives reset voltages. During such activity, at least a portion of an electrostatic force (or voltage differential) may be created between the yoke 206 and the address electrode 212a. Similarly, another portion of an electrostatic force may be created between the micro-mirror 204a and the elevated address electrode 214a. The combination of the electrostatic forces may selectively create a torque force that transitions the micro-mirror 204b to the active “on” state. Although a control voltage of three volts is described above, a control voltage of three volts is merely one example of a control voltage that may be selectively applied to address electrodes 212a, 212b. It is generally recognized that other control voltages may be used without departing from the scope of the present disclosure.

By combining the DMD 200 with a suitable light source and projection optics (described above with regard to FIG. 1), the micro-mirror 240 may reflects incident light either into or out of the pupil of the projection lens 24. Thus, the “on” state of the DMD pixel element 240 appears bright and the “off” state of the DMD pixel element 240 appears dark. Gray scale may be achieved by binary pulse width modulation of the incident light. Color may be achieved by using color filters, either stationary or rotating, in combination with one, two, or three DMDs 200.

FIGS. 3A-3D illustrate additional details of another conventional DMD pixel element 300. Although a different configuration than DMD pixel element 200 of FIG. 2, the assembled DMD pixel element 300 that is illustrated in FIG. 3A may operate in a similar manner to the DMD pixel element 200. For example, similar to the DMD pixel element 200, the DMD pixel element 300 of FIG. 3 may include a hinge portion, an address portion, and a mirror portion. Although some components within the hinge portion, the address portion, and the mirror portion may remain the same, the configuration of other components within each portion may vary slightly from that described above with regard to FIG. 2. For example, in the illustrated embodiment, the mirror portion includes a micro-mirror 304, which may be similar or different than the micro-mirror 204 of FIG. 2.

The hinge portion includes a hinge 316, supported on each side by hinge posts. As will be described in more detail with regard to FIG. 3B, six bias vias 308 support spring tips 326 and hinge 316 above the lower layer 360. The bias vias 308 may also operate to relay a bias voltage to hinge 316. Micro-mirror 304 is supported above the hinge 316 upon a single mirror via 302. In addition to providing support for the micro-mirror 304, the mirror via 302 may conductively transfer the bias voltage to the micro-mirror 304. Accordingly, in a manner similar to that described above, a bias voltage may be applied to the bias pad 330. The bias voltage may then be conductively transferred to the spring tips 326 and hinge 316 through the six bias vias 308. The bias voltage may be then further transferred from the hinge 316 to the micro-mirror 304 through the mirror via 302.

The address portion of the DMD pixel element 300 includes two address pads 312a, 312b that each connect to raised address electrodes 314a, 314b, respectively. Address pads 312a, 312b and the raised address electrodes 314a, 314b are illustrated in more detail with respect to FIGS. 3B and 3C, respectively. As illustrated in FIG. 3A, address vias 313 support the raised address electrodes 314a, 314b above each address pad 312a, 312b. In addition to supporting the raised address electrodes 314a, 314b, the address vias 313 relay a control or address voltage from the address pads 312a, 312b to the raised address electrodes 314a, 314b. In a manner similar to that described above with reference to FIG. 2, the address pads 312a, 312b may be in communication with a control circuitry, such as an SRAM cell or the like, which selectively applies a control or address voltage to one of the two address pads 312a, 312b to create an electrostatic force between the micro-mirror 304 and the raised address electrodes 314a, 314b. A similar electrostatic force may be created between the micro-mirror 304 and the address pads 312a, 312b.

The range of motion allowed to micro-mirrors 304 may be limited by spring tips 326. During operation of DMD pixel element 300, spring tips 326 provide a landing point for micro-mirror 304. For example, when micro-mirror 304 is tilted in the direction of the raised address electrode 314a and address pad 312a, one or more spring tips 326 positioned proximate these address elements may operate as a landing point for micro-mirror 304. Conversely, when micro-mirror 304 is tilted in the direction of the raised address electrode 314b and address pad 312b, one or more spring tips 326 positioned proximate these address elements may operate as a landing point for micro-mirror 304. Thus, micro-mirror 304 may be tilted in the positive or negative direction until the micro-mirror 304 contacts one or more spring tips 326.

FIGS. 3B and 3C illustrate top isolated views of the components of the conventional DMD pixel element 300 of FIG. 3A as divided into a lower layer 360 and an upper layer 380, respectively. Although the term “layer” is utilized in this description, it is recognized that the component parts of lower layer 360 may not necessarily lie in the same plane. Specifically, FIG. 3B illustrates a top isolated view of the lower layer 360, which may also be referred to as a Metal 3 or M3 layer, of the DMD pixel element 300. The DMD pixel element 300 is substantially configured in the shape of a square. Accordingly, the components of the lower layer 360 are also substantially configured in the shape of a square. There are two bias pads 330a and 330b that are coupled by an arm 365 that extends substantially across the width of the lower layer 360. For the application of a bias voltage, bias pads 330 include areas 308 that identify the proximate location for the formation of bias vias 308 (shown in FIG. 3A). Each bias pad 330 includes three areas 309 for the formation of three bias vias 308. Collectively, bias pads 330a, 330b include six areas 309 for the formation of six bias vias 308.

Lower layer 360 also includes two address pads 312a and 312b separated by an arm 365. For the application of a control voltage, address pads 312a, 312b include areas 315 that identify the proximate location for the formation of address vias 313 (shown in FIG. 3A). Each address pad 312 includes two areas 315 for the formation of two address vias 313. Accordingly, address pads 312a, 312b collectively include four areas 315 for the formation of four address vias 313.

FIG. 3C illustrates a top isolated view of a middle layer 380, which may also be referred to as beam/hinge or “binge” layer, of the DMD pixel element 300 of FIG. 3C. Although the term “layer” is utilized in this description, it is recognized that the component parts of middle layer 380 may not necessarily lie in the same plane. As illustrated in FIG. 3A, the size and shape of middle layer 380 corresponds generally with the size and shape of lower layer 360.

The middle layer 380 includes four spring tips 326, two beams 324a, 324b, a hinge 316, and two address electrodes 314a, 314b. A first beam 324a is disposed proximate a first corner 382 of middle layer 380, and a second beam 324b is disposed proximate a second corner 384 of middle layer 380. As illustrated, the hinge 316 extends substantially across the width of the middle layer 380. For coupling the bias pads 330 of the lower layer 360 with beams 324, each beam 324a, 324b includes areas 311 that identify the proximate location for the formation of bias vias 308 (shown in FIG. 3A). Accordingly, where three bias vias 308 are desired for supporting each beam 324a, 34b, each beam 324a, 324b includes three areas 311 for the formation of bias vias 308. As described above, a bias voltage applied to the bias pads 330 of the lower layer 360 may be transferred to beams 324 through bias vias 308.

The middle layer 380 also includes two raised address electrodes 314a and 314b, which are disposed on each side of hinge 316. For coupling the address pads 312 of the lower layer 360 to the address electrodes 314 of the middle layer 380, address electrodes 314a, 314b include areas 317 that identify the proximate location for the formation of address vias 313 (shown in FIG. 3A). Each address electrode 314a, 314b includes two areas 317 for the formation of two address vias 313. Accordingly, address electrodes 314a, 314b collectively include four areas 317 for the formation of four address vias 313. As described above, a control voltage applied to the address pads 312 of the lower layer 360 may be transferred to address electrodes 314 through address vias 313. The control voltage may then be transferred to an upper layer, which comprises the micro-mirror 304, for the selective tilting of micro-mirror 304 to an “off” state or an “on” state.

FIG. 3D generally shows an side isolated view of the micro-mirror of FIG. 3A tilting towards an address pad 312a/address electrode 314a. For purposes of illustration, other component parts of the DMD pixel element 300 have been removed. The mirror 304 may be charged with a bias voltage. Absent any application of voltage, both the 312a/address electrode 314a and 312b/address electrode 314b may have a charge of zero volts. Address pad 312b/address electrode 314b upon being selected by control circuitry (not explicitly shown) may receive a control or address voltage of three volts. A greater electrostatic attraction between the mirror and the address pad 312a/raised address electrode 314a may tilt the mirror (via the hinge 316, seen better in FIG. 3A) towards the address pad 312a/address 314a. Arrows 352 and 354 are two locations where strong electrostatic forces are created, for example, between the address pad 312a and the micro-mirror 304 (arrow 352) and the raised address electrode 314a and the micro-mirror 304 (arrow 354).

The mirror may be tilted in a similar manner towards address pad 312b/address electrode 314b by applying three volts to the address pad 312a/address 314a and removing the three volts from the address pad 312b/address 314b, for example, to return the address pad 312b/address 314b to a voltage of zero. Although three volts has been been described as the control or address voltage in this embodiment, other voltages may be utilized to create a greater electrostatic differential on one side of the micro-mirror 304 in other embodiments. For example, the control or address voltage may be a negative voltage.

Each micro-mirror of a DMD array may correspond to a pixel in a displayed image. For a variety of reasons, it may be desirable to decrease the size of a DMD pixel element. For example, given a fixed die size for a DMD array, a decrease in the size of the DMD pixel element may increase the resolution. Additionally, given a fixed number of micro-mirrors in a DMD array, a decrease in the size of the DMD pixel elements may decrease the size of the die for the DMD array, which in turn may increase the production yield (e.g., more chips per wafer). A simple scaling of some DMD pixel elements such as the DMD pixel element 300 of FIG. 3A to a smaller size may be infeasible in certain circumstances. For example, among other items, a scaling of the DMD pixel element 300 of FIG. 3A to a reduced size may necessitate lower electrostatics (e.g., less electrostatic force to tilt the micro-mirror 304 about hinges 316), thinner hinges 316 (e.g., to allow the micro-mirror to tilt properly), and higher aspect ratio vias between the lower layer 330 and the middle layer 380 (e.g, when the vias are shrunk, they might not function properly). Additionally resistance in the mirror via 302 may increase as the micro-mirror 304 gets smaller. Furthermore, a lower vertical space between the micro-mirror 304 and the middle layer 380 may result in electrical shorting—e.g., in the areas indicated by arrows 352 and 354—due to different voltage levels between the micro-mirror 304 and the address pad 312a or 312b and the micro-mirror 304 and the address electrodes 314a or 314b. Additionally, the elevated address electrode 314a, 314b may not receive a suitable address voltage if the shrunken address vias 313 are not sized large enough to be fully conductive. Accordingly, teachings of embodiments of the invention recognize configurations which may facilitate smaller DMD pixel element designs.

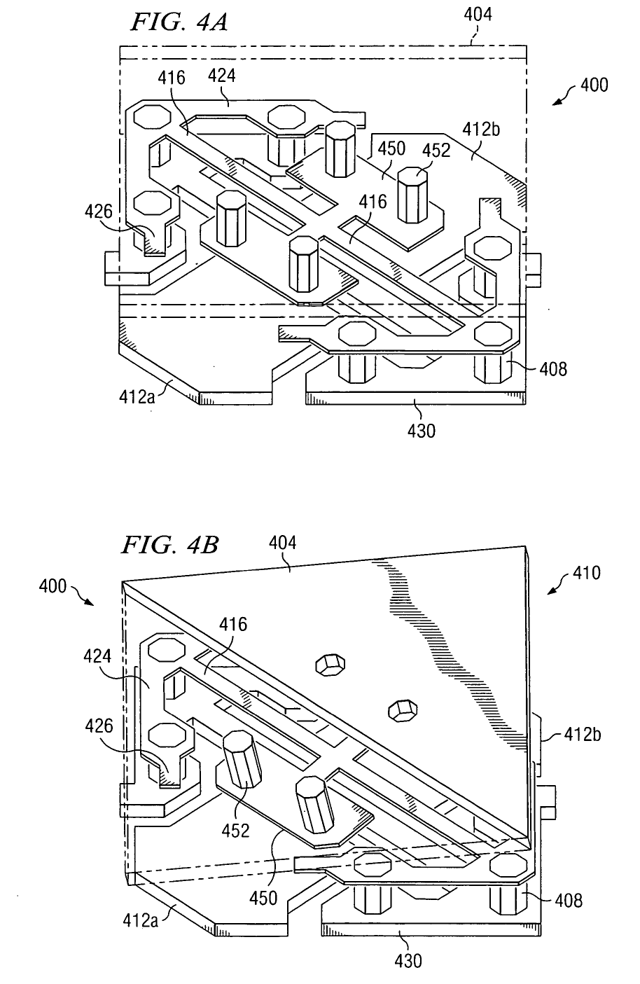

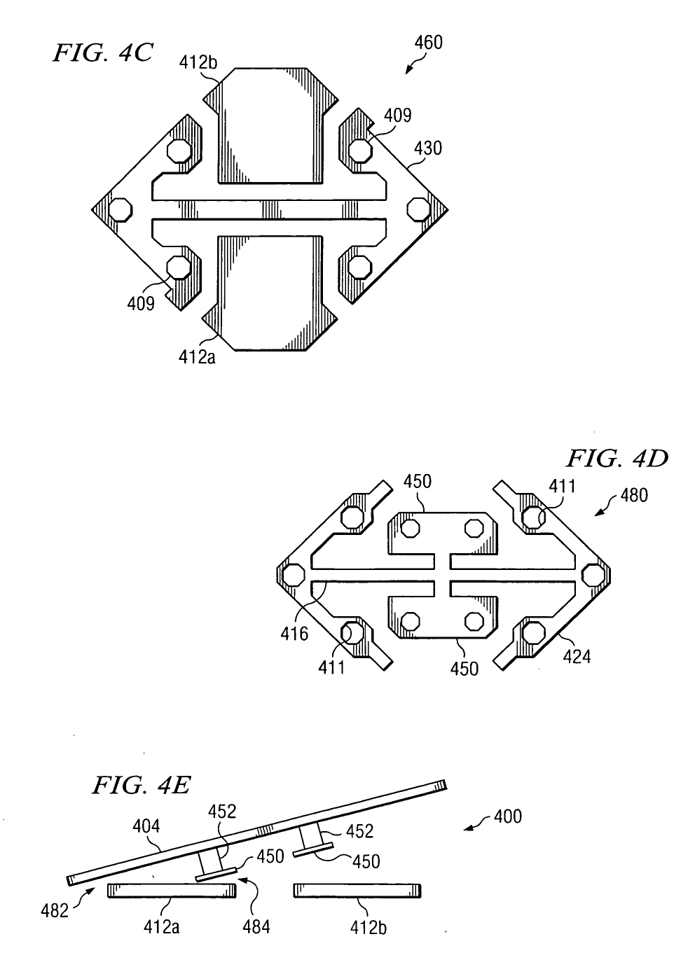

FIGS. 4A and 4B illustrate a DMD pixel element 400, according to an embodiment of the invention. For purposes of illustration, a micro-mirror 404 has been ghosted in FIG. 4A and partially ghosted in FIG. 4B. The DMD pixel element 400 of FIGS. 4A and 4B may operate in a similar manner to the DMD pixel elements of FIGS. 1 through 3D except for the differences described below. The DMD pixel element 400 may include a lower layer 460, a middle layer 480, and a mirror layer 410.

The lower layer 460 includes two address pads 412a, 412b. In a manner similar to that described above with reference to FIGS. 2 and 3A, the address pads 412a, 412b may be in communication with a control circuitry (e.g., SRAM cell or the like) which selectively applies a control or address voltage to one of the two address pads 412a, 412b to create an electrostatic force between the micro-mirror 404 and the address pad (412a or 412b) and/or the rotating beam 450 and the address pad (412a or 412b). In operation, the electrostatic attraction forces rotation of the micro-mirror 404 and rotating beam 450 to one of the address pads 412a, 412b.

The middle layer 480 of the DMD pixel element 400 may include one or more hinges 416 and a rotating beam 450. The rotating beam 450 may be coupled to the one or more hinges 416. Six bias vias 408 support the beam 424, the one or more hinges 416, and the rotating beam 450 above the lower layer 460. In operation, the rotating beam 450 may rotate with the one or more hinge 416. Although six bias vias 416 are shown in this embodiment, more or less may be utilized in other embodiments. The bias voltage may be applied to the bias pad 430 in the lower layer and relayed to the beam 424, hinge 416, and mirror vias 452 through the six bias vias 408. In operation the bias voltage may be further relayed to the micro-mirro 404 through the plurality of mirror vias 452.

The spring tips 426 on the edge of the beam 424 may provide a landing point for the micro-mirror 404 upon tilting towards one of the address pad 412a, 412b. The spring tips 426 may be modified to facilitate a desired tilt angle of the micro-mirror 404. For example, in this embodiment, the spring tips 426 may allow a tilt of plus or minus twelve degrees. In other embodiments, the spring tips may allow a tilt of more than or less than plus or minus twelve degrees.

The mirror portion 410 includes a micro-mirror 404, which may be similar or different from the micro-mirrors 204, 304 of FIGS. 2 and 3A. The single mirror via 302 of FIG. 3A has been eliminated, allowing the hinge 416 in some embodiments to be longer. The micro-mirror 404 of FIGS. 4A and 4B are supported above the hinge 416 upon a plurality of mirror vias 452 (four mirror vias 452 shown in this embodiment), which couple the micro-mirror to the rotating beam 450. The plurality of mirror vias 452 may reduce variability in electrical resistance and increase mechanical integrity of the mirror via, as compared to the single mirror via 302 of FIG. 3A. Although four mirror vias 452 are shown in this embodiment, more or less mirror vias may be utilized in other embodiments. The mirror vias 452, in addition to providing support for the micro-mirror 404, may conduct a bias voltage to the micro-mirror 404.

FIGS. 4C and 4D illustrate top isolated views of the components of the embodiment of the DMD pixel element 400 of FIGS. 4A and 4B as divided into a lower layer 460 and a middle layer 480, respectively. FIG. 4C illustrates a top isolated view of the lower layer 460, which may also be referred to as Metal 3 or M3 layer. Although the term “layer” is utilized in this description, the component parts in lower layer 460 may not necessarily be in the same plane. The lower layer 460 of FIG. 4C includes the bias pad 430 and the address pads 412a, 412b. The bias pads 430 show areas 409 for six bias vias 408 (not explicitly shown). The bias pad 430 receives a bias voltage and one of the address pads 412a or 412b receives an address or control voltage.

FIG. 4D illustrates a top isolated view of a middle layer 480 (also referred to as beam/hinge or “binge” layer) of the DMD pixel element 400 of FIGS. 4A and 4B. Once again, although the term “layer” is utilized in this description, the component parts in the middle layer 480 may not necessarily be in the same plane. The middle layer 480 includes the beams 424, the spring tips 426, the hinge 416, and the rotating beam 450. Areas 411 identify the locations of the six bias vias 408. The entire middle layer 480 (e.g., the beam 424, the spring tips 426, the hinge 416, and the rotating beam 450) may receive the bias voltage.

FIG. 4E shows a side isolated view of the micro-mirror 404 of FIGS. 4A and 4B tilting towards address pad 412a, according to an embodiment of the invention. For purposes of illustration, other component parts of the DMD pixel element 400 are not shown. The micro-mirror 404, mirror vias 452, and rotating beam 450 may be charged with a bias voltage. Address pad 412b upon selection by the control circuitry (not explicitly shown) may receive a control or address voltage. As a result of this selection, address pad 412a may have a lower voltage than address pad 412b (e.g., zero volts). A greater electrostatic difference between the micro-mirror 404/rotating beam 450 and the address pad 412a may tilt the micro-mirror 404 and rotating beam 450 (via the hinge 416, seen better in FIGS. 4A and 4B) towards the address pad 412a. Arrows 482 and 484 indicate two areas where electrostatic forces may be stronger, for example, between the address pad 412a and the micro-mirror 404 (arrow 482) and the address pad 412a and the rotating beam 450 (arrow 484).

The micro-mirror 404/rotating beam 450 may be tilted in a similar manner towards address pad 412b by applying a control or address voltage to the address pad 412a and zero volt to the address pad 412b.

The embodiments shown in FIGS. 4A through 4E may facilitate a scalable DMD pixel design that allows lower electrostatics and smaller interaction areas (e.g., between the bias portion and address portion) in a reduced sized DMD pixel element. The rotating beam 450 (in a similar location to the address electrodes 314a, 314b of FIG. 3A) does not receive the address voltage, but rather receive a bias voltage. Thus, the bias voltage is taken down to a lower height—e.g., through the rotating beam 450. A potential for an electrical shorting is reduced, if not eliminated, because the rotating beam 450 receives the bias voltage and rotate above a layer coated with oxide.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A micro-mirror element comprising:
a lower layer;
a middle layer including at least one hinge, wherein the entire middle layer is operable to receive a bias charge; and
a micro-mirror, the micro-mirror operable to receive the bias charge from the middle layer.

2. The micro-mirror element of claim 1, wherein the middle layer further includes a rotating beam coupled to the at least one hinge.

3. The micro-mirror element of claim 2, further comprising:
at least one via coupled to the beam and the micro-mirror, wherein the at least one via is operable to transfer the bias charge from the middle layer to the micro-mirror.

4. The micro-mirror element of claim 3, wherein the at least one via is a plurality of vias.

5. The micro-mirror element of claim 1, wherein the lower layer is operable to receive at least an address charge.

6. The micro-mirror element of claim 5, wherein the address charge is only applied to the lower layer.

7. The micro-mirror element of claim 5, wherein the lower layer is further operable to receive a bias charge.

8. The micro-mirror element of claim 7, further comprising at least three bias vias operable to transfer the bias charge from the lower layer to the middle layer.

9. The micro-mirror element of claim 5, wherein the middle layer further includes a beam with at least one spring tip.

10. A micro-mirror element comprising:
a mirror layer with a micro-mirror;
a middle layer coupled to the micro mirror and having at least one hinge and a rotating beam;
a lower layer; and
at least three bias vias disposed between the lower layer and the middle layer.

11. The micro-mirror element of claim 10, further comprising:
a plurality of vias disposed between the middle layer and the mirror layer.

12. The micro-mirror element of claim 11, wherein the plurality of vias are coupled to the rotating beam and the micro-mirror.

13. The micro-mirror element of claim 12, wherein the plurality of vias are at least four vias.

14. The micro-mirror element of claim 10, further comprising:
an address portion operable to receive an address charge, wherein the entire address portion resides only in the lower layer.

15. The micro-mirror element of claim 14, wherein the entire middle layer is operable to receive a bias charge.

16. The micro-mirror element of claim 10, wherein the entire middle layer is operable to receive a bias charge.

17. A method of tilting a digital micro-mirror pixel element:
providing a micro-mirror element with a lower layer, a middle layer, and a micro-mirror;
applying a bias charge to the entire middle layer;
creating an electrostatic differential by applying an address charge to at least a portion of the lower layer, the electrostatic differential tilting the micro-mirror.

18. The method of claim 17, wherein the address charge is only applied to the lower layer.

19. The method of claim 17, further comprising:
conducting, with a plurality of vias, a bias charge from the middle layer to the micro-mirror.

20. The method of claim 17, wherein applying the address charge to the entire middle layer is carried out by at least three bias vias.
